(19) United States
(12) Patent Application Publication
(10) Pub. No.: US 2014/0099819 A1
(43) Pub. Date: Apr. 10, 2014

(54) BATTERY TERMINAL SYSTEM

(71) Applicant: EnerDel, Inc., Greenfield, IN (US)

(72) Inventors: Bruce James Silk, Indianapolis, IN (US); George Brutchen, Winchester, IN (US); Derrick Scott Buck, Pendleton, IN (US); Kelly B. Ledbetter, Carmel, IN (US)

(73) Assignee: EnerDel, Inc., Greenfield, IN (US)

(21) Appl. No.: 14/052,277

(22) Filed: Oct. 11, 2013

Related U.S. Application Data
(63) Continuation of application No. PCT/US12/33785, filed on Apr. 16, 2012.
(60) Provisional application No. 61/476,037, filed on Apr. 15, 2011.
(60) Provisional application No. 61/483,428, filed on May 6, 2011.

(51) Int. Cl. H01R 11/11

(52) U.S. Cl. CPC H01R 11/11
USPC 439/507

(57) ABSTRACT

Battery terminal systems are provided for coupling a first battery to a second battery. The battery terminal systems may include bases assembled to the terminals of the first battery and the second battery. The bases being coupled to a jumper to electrically couple the first battery to the second battery.

### RELATED APPLICATIONS

This application is a continuation of PCT Application No. PCT/US12/33785, filed Apr. 16, 2012, titled BATTERY TERMINAL SYSTEM, docket ENER1-P11-011-01-WO which claims the benefit of U.S. Provisional Application Ser. No. 61/476,037, filed Apr. 15, 2011, titled BATTERY TERMINAL SYSTEM and claims the benefit of U.S. Provisional Application Ser. No. 61/483,428, filed May 6, 2011, titled BATTERY TERMINAL SYSTEM, the disclosures of which are expressly incorporated by reference herein.

### FIELD

The present invention is directed to systems and methods to related to battery technology, specifically to lithium-ion batteries and interconnection methods thereof. In one aspect, the battery interconnect method creates a terminal system with a jumper that is removably affixed to the battery cell terminal.

### BACKGROUND

Current battery construction provides for a metalized terminal that is flat or, in some applications, has a raised projection on the positive terminal. For reference, these terminals having a raised projection on the positive terminal are commonly found on the readily available AA, C, D, 18650, 25650 style cylindrical cells. While other terminal examples exist (post and snap-clip, such as that seen in a typical 9V batter), this disclosure will address the flat terminal type exclusively. Another exemplary flat terminal battery is the SCIB brand super charge ion battery available from Toshiba International Corporation—Industrial Division located at 13131 West Little York Road in Houston, Tex. 77041. This battery has a raised positive terminal and a raised negative terminal on its side.

Simple methods to connect battery cells with flat terminals include spring contacts such as those used in a flashlight. Benefits to spring contacts are that there is little capital investment needed to employ spring terminals and the battery assembly can be taken apart and serviced. The drawback to this method is that the spring contact is generally not robust enough to handle high currents.

On the other end of the spectrum, a complex method to connect cells with flat terminals utilizes a laser to weld the cell tab and a contact connector. This method provides for a good electro-mechanical joint but the equipment costs are very expensive and the battery assembly is not serviceable.

There still exists a need to develop a method to connect battery cells that provides a robust electro-mechanical connection of a jumper tab and a battery cell terminal that is removable, i.e. re-workable, with minimal changes from the existing design.

### SUMMARY

In an exemplary embodiment of the present disclosure, a battery terminal system connecting a first battery terminal of a first battery to a second battery terminal of a second battery is provided. The system comprising a jumper electrically coupled to the first battery terminal of the first battery and electrically coupled to the second battery terminal of the second battery; a primary mechanical connection securing the jumper to the first battery terminal of the first battery; and a primary electrical connection electrically coupling the jumper to the first battery terminal of the first battery. The primary electrical connection providing a lower resistance electrical path between the first battery terminal of the first battery and the jumper than the primary mechanical connection. In one example thereof, the jumper includes at least a first feature to receive a conductive wettable material, the conductive wettable material forming the primary electrical connection. In a variation thereof, the conductive wettable material contacts the first battery terminal and contacts the jumper. In a further variation thereof, the first battery terminal has a base surface protruding from the first battery, the jumper being coupled to the base surface through one of ultrasonic welding and resistance welding. In another variation thereof, the first battery terminal has a base surface protruding from the first battery and at least one protrusion extending outward from the base surface away from the first battery, the jumper including at least a second feature to receive the at least one protrusion to couple the jumper to the first battery terminal. In a variation of the further variation, the first feature is an opening through the jumper, the conductive wettable material flowing from a top surface of the jumper through the opening to a bottom surface of the jumper contacting the first battery terminal, the conductive wettable material contacting both the first battery terminal and the jumper. In yet another variation, the first battery terminal has a base surface protruding from the first battery and at least one recess extending inward from the base surface towards the first battery and further comprising at least one retainer cooperating with at least a second feature of the jumper and the at least one recess of the first battery terminal to hold the jumper relative to the first battery terminal and forming the primary mechanical connection. In a variation of the yet another variation, the first feature is an opening through the jumper, the conductive wettable material flowing from a top surface of the jumper through the opening to a bottom surface of the jumper contacting the first battery terminal, the conductive wettable material contacting both the first battery terminal and the jumper. In another example thereof, the conductive wettable material contacts the jumper and contacts a base positioned between the jumper and the first battery terminal, the base in cooperation with the conductive wettable material electrically coupling the jumper and the first battery terminal.

In another exemplary embodiment of the present disclosure, a battery terminal system connecting a first battery terminal of a first battery to a second battery terminal of a second battery is provided. The system comprising a first base coupled to the first battery terminal of the first battery; a jumper removably coupled to the first base, the jumper being electrically coupled to the first battery terminal of the first battery through the first base and electrically coupled to the second battery terminal of the second battery resulting in the first battery terminal of the first battery being electrically coupled to the second battery terminal of the second battery; and at least one retainer securing the jumper to the first base. In an example thereof, the first base is coupled to a base surface of the first battery terminal through one of ultrasonic welding and resistance welding. In another example thereof, the first base includes a bottom portion coupled to a base surface of the first battery terminal of the first battery and a top portion including a jumper seat surface and at least one protrusion extending outward from the jumper seat surface, the jumper including at least one opening to receive the at least one protrusion, the at least one retainer being coupled to the at least one protrusion, the at least one protrusion and the at least one retainer cooperating to couple the jumper to the first base. In a variation thereof, the jumper further includes at least one wicking opening extending from a top surface of the jumper to a bottom surface of the jumper contacting the jumper seat surface of the first base, a conductive wettable material being positioned within the at least one wicking opening and contacting both the first base and the jumper. In a variation of the variation, the at least one wicking opening and the at least one opening intersect. In yet another example, the first base includes a bottom portion coupled to a base surface of the first battery terminal of the first battery and a top portion including a jumper seat surface and at least one recess extending inward from the jumper seat surface, the jumper including at least one opening to receive the at least one retainer, the at least one retainer passing into the at least one recess, the first base and the at least one retainer cooperating to couple the jumper to the first base. In a varaition thereof, the jumper further includes at least one wicking opening extending from a top surface of the jumper to a bottom surface of the jumper contacting the jumper seat surface of the first base, a conductive wettable material being positioned within the at least one wicking opening and contacting both the first base and the jumper. In still another example, the at least one retainer is coupled to the first base to capture the jumper between the at least one retainer and the first base and to hold the jumper in electrical contact with the first base. In yet still another example, the at least one retainer is spaced apart from the first battery terminal of the first battery, the first base being positioned between the at least one retainer and the first battery terminal of the first battery. In still a further example, the jumper is spaced apart from the first battery terminal of the first battery, the first base being positioned between the jumper and the first battery terminal of the first battery.

In a further exemplary embodiment of the present disclosure, a battery terminal system connecting a first battery terminal of a first battery to a second battery terminal of a second battery is provided. The system comprising a jumper including a first portion electrically coupled to the first battery terminal of the first battery and a second portion electrically coupled to the second battery terminal of the second battery resulting in the first battery terminal of the first battery being electrically coupled to the second battery terminal of the second battery, the first portion including at least one wicking opening; and a conductive wettable material positioned within the at least one wicking opening. In an example thereof, the conductive wettable material forms a primary electrical connection between the jumper and the first battery terminal of the first battery terminal of the first battery. In a variation thereof, the first portion of the jumper includes at least one opening to receive at least one feature that locates the first portion of the jumper relative to the first battery terminal of the first battery, the at least one opening intersecting the at least one wicking opening. In a variation of the variation, a first wicking opening extends radially from a first opening which receives a first feature. In one variation, the first feature is one of a protrusion and a fastener.

The above and other features of the present disclosure, which alone or in any combination may comprise patentable subject matter, will become apparent from the following description and the attached drawings.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 illustrates an exemplary battery arrangement connected to a load, the battery arrangement including a plurality of batteries and a plurality of exemplary battery terminal systems interconnecting the batteries;

FIG. 2 illustrates an exemplary battery arrangement connected to a load, the battery arrangement including a plurality of batteries and a plurality of exemplary battery terminal systems interconnecting the batteries;

FIG. 3A illustrates two batteries and an exemplary jumper spaced apart from the two batteries;

FIG. 3B illustrates the exemplary jumper of FIG. 3A overlapping a first battery terminal of the first battery and a second battery terminal of the second battery, the jumper electrically coupling the first terminal of the first battery to the second terminal of the second battery;

FIG. 3C illustrates a side view of the jumper and the first battery terminal of the first battery;

FIG. 4 illustrates an exemplary battery terminal having a base surface and a protrusion extending above the base surface;

FIG. 5 illustrates the battery terminal of FIG. 4 and a portion of the exemplary jumper of FIG. 3A;

FIG. 5A illustrates a portion of another exemplary jumper;

FIG. 6 illustrates the jumper of FIG. 5 coupled to the battery terminal of FIG. 5;

FIG. 7 illustrates an exemplary battery terminal having a base surface and a recess extending below the base surface;

FIG. 8 illustrates the exemplary jumper of FIG. 5, the exemplary battery terminal of FIG. 7, an exemplary retainer to couple the jumper to the battery terminal, and a conductive wettable material to provide a primary electrical connection between the battery terminal and the jumper;

FIG. 9 illustrates the components of FIG. 8 assembled;

FIG. 10 illustrates an exemplary base battery terminal including a base member, a fastener which provides a fastener above a seat surface of the base member, and a retainer;

FIG. 11 illustrates another exemplary base member;

FIG. 12 illustrates a pair of base battery terminals and a battery having a pair of battery terminals;

FIG. 13 illustrates an exemplary base battery terminal having a stepped base member;

FIG. 14 illustrates a representative sectional view of the base battery terminal of FIG. 13, an exemplary jumper, and an exemplary battery terminal;

FIG. 15 illustrates the exemplary jumper of FIG. 5, an exemplary base battery terminal, an exemplary retainer to couple the jumper to the base battery terminal, and a conductive wettable material to provide a primary electrical connection between the base battery terminal and the jumper;

FIG. 16 illustrates the components of FIG. 15 assembled; and

FIGS. 17 and 18 illustrate an alternative arrangement for the base battery terminal.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

The embodiments disclosed herein are not intended to be exhaustive or to limit the invention to the precise forms disclosed in the following detailed description. Rather, the embodiments are chosen and described so that others skilled in the art may utilize their teachings. The battery interconnection systems and battery systems disclosed herein may be used in multiple applications. Exemplary applications include storing and providing energy to a power grid, providing power to a vehicle to propel the vehicle, and providing an uninterrupted power supply for computing devices and other equipment in data centers.

In the batteries of this disclosure, a terminal is present that protrudes from the body of the battery cell to facilitate connection to a second battery cell, where said connection may be in series or parallel. Further, the terminal referred to herein may be the positive terminal, the negative terminal, or both. The terminal may have no technically or physically significant topography; i.e. it may be flat. But in other aspects, it may include a small raised portion or other designs intentionally created therein to facilitate identification of the polarity of the terminal or the existing joining method. The terminals may have any suitable geometric shape overall, such as circular, rectangular, or square. An exemplary flat terminal battery is the SCIB brand super charge ion battery available from Toshiba International Corporation—Industrial Division located at 13131 West Little York Road in Houston, Tex. 77041.

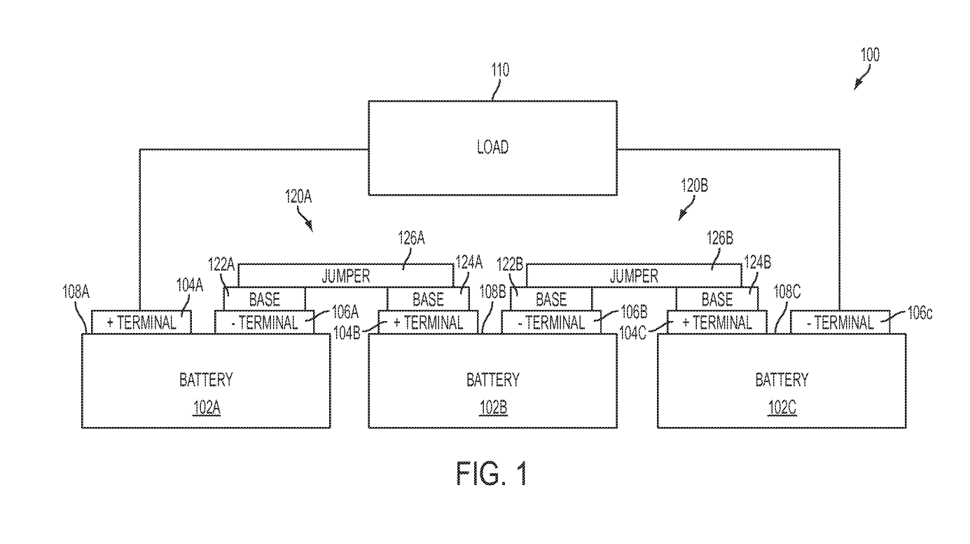

Referring to FIG. 1, a battery arrangement 100 is shown. Battery arrangement 100 includes a plurality of batteries 102, illustratively batteries 102A-C. Each battery 102 may be a single cell or a plurality of cells coupled together. Each battery includes a positive terminal 104 and a negative terminal 106. In the illustrated embodiment, for each battery 102, the respective positive terminal 104 and negative terminal 106 extend above a top surface 108 of battery 102.

An electrical circuit is made when battery arrangement 100 is electrically coupled to a load 110. Exemplary loads include electric motors, lights, computers, the energy grid, and other devices which utilize electrical power. Load 110 is electrically coupled to positive terminal 104A of battery 102A and negative terminal 106C of battery 102C. In one embodiment, battery arrangement 100 is electrically coupled to a charger (not shown) instead of a load. The charger charging the batteries 102 of battery arrangement 100.

To complete the electrical circuit a battery terminal system 120A electrically couples negative terminal 106A of battery 102A to positive terminal 104B of battery 102B and a battery terminal system 120B electrically couples negative terminal 106B of battery 102B to positive terminal 104C of battery 102C. Battery terminal system 120A and battery terminal system 120B provide a robust electrical connection able to handle high current loads while still permitting the respective batteries 102 to be uncoupled for servicing. The battery terminal system is able to handle high current loads due to the resistance of the battery terminal system being lower than the resistance of the batteries. Thus, the resistance of the battery terminal system is not the limiting factor on the current load of the system. The batteries 102 are shown coupled together in series. Other arrangements of batteries 102 are contemplated, including one or more of batteries 102 being coupled together in parallel.

Battery terminal system 120A includes a first base 122A coupled to negative terminal 106A and a second base 124A coupled to positive terminal 104B of battery 102B. In one embodiment, first base 122A and second base 124A are identical. Battery terminal system 120A further includes a jumper 126A removably coupled to the first base 122A and the second base 124A. The jumper 126A acts as a buss bar by being electrically coupled to negative terminal 106A of battery 102A through first base 122A and electrically coupled to positive terminal 104B of battery 102B through second base 124A resulting in negative terminal 106A of battery 102A being electrically coupled to positive terminal 104B of battery 102B. In one embodiment, at least one retainer secures jumper 126A to second base 124A.

In one embodiment of battery terminal system 120A, first base 122A is coupled to a top base surface of the negative terminal 106A through one of laser welding, ultrasonic welding, and resistance welding. In one embodiment of battery terminal system 120A, first base 122A includes a bottom portion coupled to a top base surface of negative terminal 106A of battery 102A and a top portion including a jumper seat surface and at least one protrusion extending outward from the jumper seat surface. Jumper 126A includes at least one opening to receive the at least one protrusion. At least one retainer being coupled to the at least one protrusion. The at least one protrusion and the at least one retainer cooperating to couple the jumper 126A to first base 122A. In one embodiment, the jumper 126A further includes at least one wicking opening extending from a top surface of the jumper 126A to a bottom surface of the jumper 126A contacting the jumper seat surface of the first base 122A. A conductive wettable material is positioned within the at least one wicking opening and contacts both the first base and the jumper. In one example, the at least one wicking opening and the at least one opening intersect.

In one embodiment of battery terminal system 120A, first base 122A includes a bottom portion coupled to a base surface of negative terminal 106A of battery 102A and a top portion including a jumper seat surface and at least one recess extending inward from the jumper seat surface. The jumper 126A includes at least one opening to receive the at least one retainer. The at least one retainer passing into the at least one recess. The first base 122A and the at least one retainer cooperating to couple the jumper 126A to the first base 122A. In one embodiment, the jumper 126A further includes at least one wicking opening extending from a top surface of the jumper 126A to a bottom surface of the jumper 126A which is contacting the jumper seat surface of the first base 122A. A conductive wettable material is positioned within the at least one wicking opening and contacts both the first base and the jumper. In one example, the at least one wicking opening and the at least one opening intersect.

In one embodiment of battery terminal system 120A, at least one retainer is coupled to first base 122A to capture jumper 126A between the at least one retainer and first base 122A and to hold jumper 126A in electrical contact with first base 122A. In the illustrated embodiment, the jumper 126A is spaced apart from negative terminal 106A of battery 102A. The first base 122A being positioned between jumper 126A and negative terminal 106A of battery 102A. In one embodiment, the at least one retainer is spaced apart from negative terminal 106A of battery 102A. The first base 122A being positioned between the at least one retainer and negative terminal 106A of battery 102A.

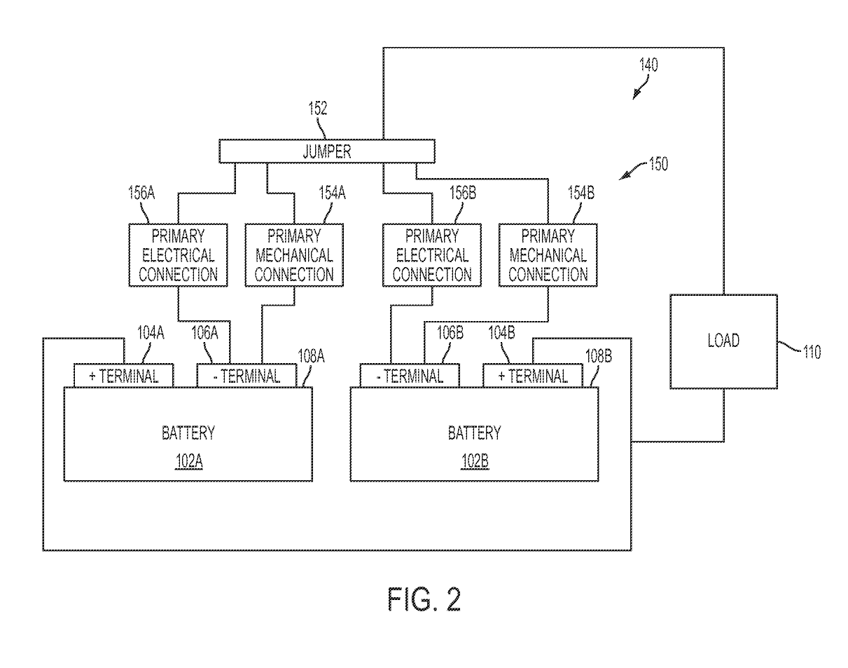

Referring to FIG. 2, another battery arrangement 140 is shown. Battery arrangement 140 includes battery 102A and battery 102B each coupled to load 110. The electrical circuit is completed by coupling negative terminal 106A of battery 102A to negative terminal 106B of battery 102B through a battery terminal system 150. The batteries 102 are shown coupled together in parallel. Other arrangements of batteries 102 are contemplated, including one or more of batteries 102 being coupled together in series.

Battery terminal system 150 includes a jumper 152 electrically coupled to negative terminal 106A of battery 102A and electrically coupled to negative terminal 106B of battery 102B. Battery terminal system 150 further a primary mechanical connection 154A securing the jumper 152 to the negative terminal 106A of battery 102A and a primary mechanical connection 154B securing the jumper 152 to the negative terminal 106B of battery 102B. Battery terminal system 150 further includes a primary electrical connection 156A electrically coupling the jumper 152 to negative terminal 106A of battery 102A. The primary electrical connection 156A providing a lower resistance electrical path between negative terminal 106A of battery 102A and the jumper 152 than the primary mechanical connection 154A. Battery terminal system 150 further includes a primary electrical connection 156B electrically coupling the jumper 152 to negative terminal 106B of battery 102B. The primary electrical connection 156B providing a lower resistance electrical path between negative terminal 106B of battery 102B and the jumper 152 than the primary mechanical connection 154B.

In one embodiment, jumper 152 includes at least a first feature to receive a conductive wettable material. The conductive wettable material forming the primary electrical connection 156A. The conductive wettable material contacts negative terminal 106A of battery 102A and contacts jumper 152.

In one embodiment, negative terminal 106A of battery 102A includes a base surface protruding from the first battery. Jumper 152 is coupled to the base surface through one of ultrasonic welding and resistance welding. In one embodiment, an intermediate base is positioned between jumper 152 and the negative terminal 106A. The intermediate base may be coupled to the negative terminal through one of laser welding, ultrasonic welding, and resistance welding.

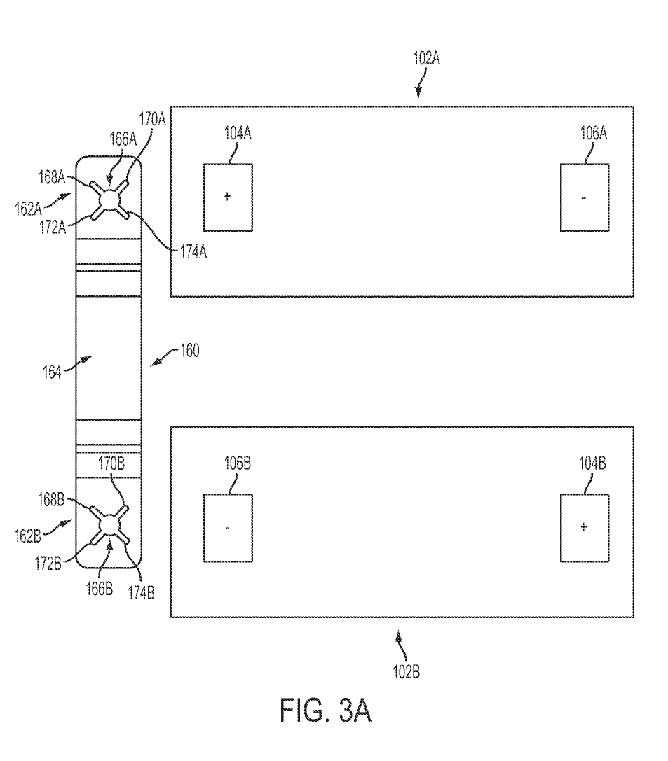

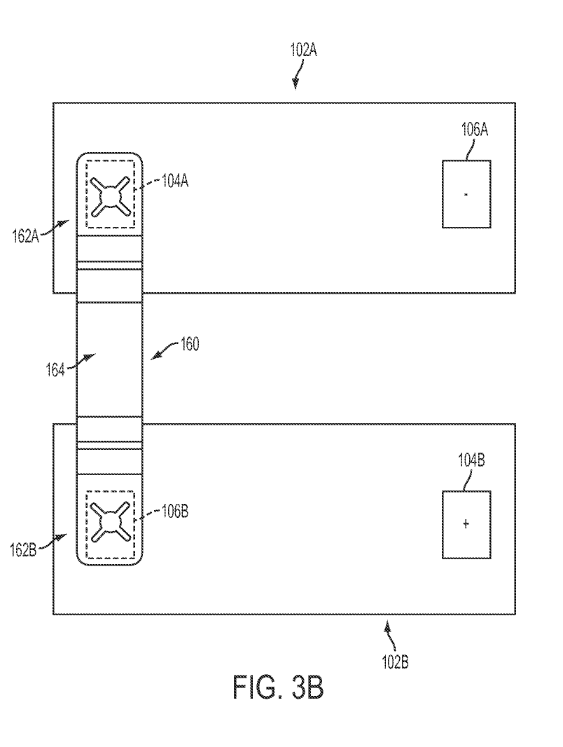

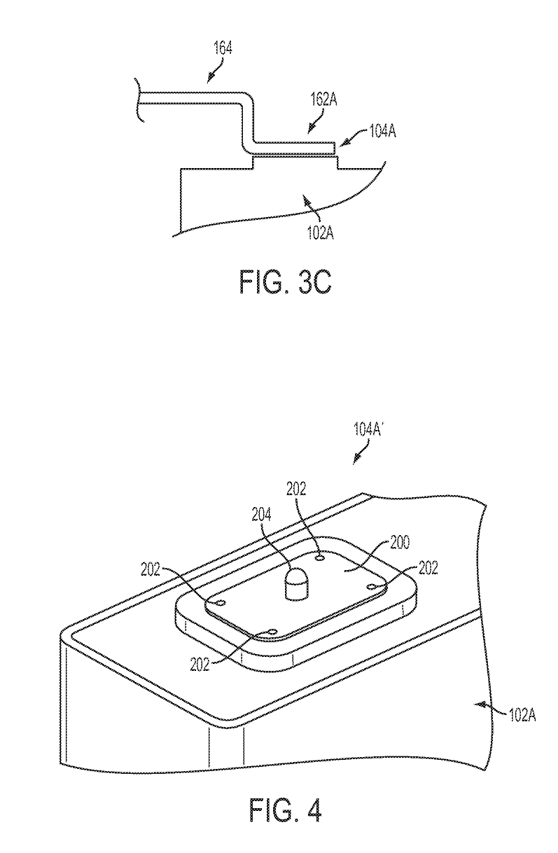

Referring to FIG. 3, an exemplary jumper 160 is shown. Jumper 160 includes a first portion 162A which overlaps positive terminal 104A of battery 102A (see FIG. 3B) and a second portion 162B which overlaps negative terminal 106B of battery 102B (see FIG. 3B). A connecting portion 164 connects first portion 162A and second portion 162B.

Each of first portion 162A and second portion 162B include a respective opening 166 which receives one of a protrusion and a mechanical fastener to locate jumper 160 relative to the respective battery 102. Further, each of first portion 162A and second portion 162B includes a plurality of wicking openings 168-174 which receive a conductive wettable material. In the illustrated embodiment, the plurality of wicking openings 168-174 intersect the respective opening 166.

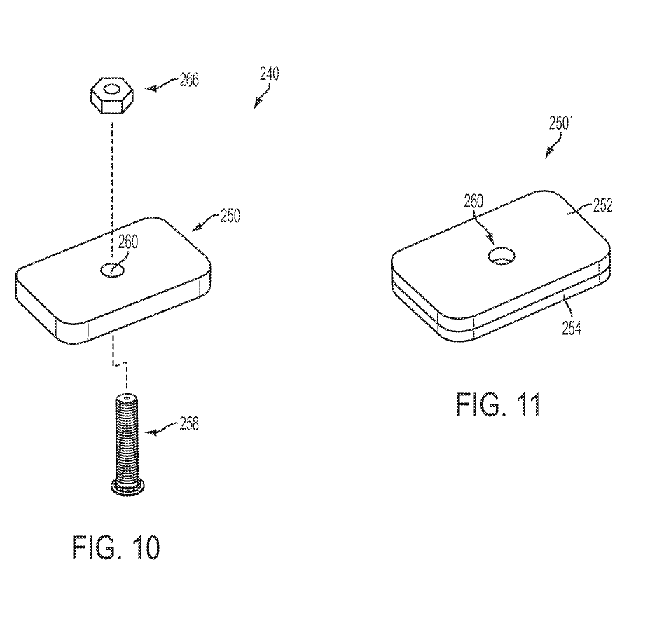

The systems and methods described herein include features or steps to ensure both a robust mechanical and electrical connection between a jumper tab and a battery terminal. The embodiments described in connection with FIGS. 4-9 require geometry updates to a standard or known battery cell terminal design. The embodiments described in connection with FIGS. 10-18 may be used directly with standard battery cell terminals.

Referring to FIG. 4, an exemplary terminal 104A′ of battery 102A is illustrated. Positive terminal 104A′ includes at least one energy directing member 202 provided on a base surface 200 of positive terminal 104A′. The energy directing member 202 facilitate the joining method of jumper 160 to positive terminal 104A′ by serving as the focal point for energy being introduced during the joining method. The actual number of energy directing members 202 may be adapted for the particular shape of the terminal 104A′ and the joining method to create a suitable joint connection. For example, the terminal 104A′ may comprise at least one energy directing member 202 on opposite sides of the terminal for at least two energy directing members 202. In another application, the terminal 104A′ may comprise at least four energy directing members 202, such as in each corner of a rectangular-shaped terminal, as shown in FIG. 4.

The terminal 104A′ further comprises a protrusion, illustratively a locator pin 204, that ensures proper alignment of the jumper portion 162A on the terminal 104A′. The locator pin 204 is received within hole 166A of jumper portion 162A. In the illustrated embodiment, locator pin 204 has a ball shaped top which assists in centering hole 166A of jumper 160 around locator pin 204. In addition, locator pin 204 adds mechanical strength to the joint formed between jumper portion 162A and terminal 104A′. The actual number and location of locator pins 204 may be adapted for the particular shape of the terminal 104A′ and jumper portion 162A. For example, the terminal 104A′ may comprise one locator pin 204 at the center of the terminal 104A′, as shown in FIG. 4.

Referring to FIG. 3C, portion 164 is raised relative to portion 162A. Portion 164 is connected to portion 162A through a generally upward extending wall portion having rounded transitions to each of portion 164 and portion 162A. A similar shape is provided between portion 164 and portion 162B. The shape of jumper 160 provides flexibility in the overall length of jumper 160 to ease the assembly of jumper 160 to respective batteries 102. Further, the flexibility in the length of jumper 160 permits jumper 160 to flex when the overall battery assembly 100 experiences vibration or shock. The flexing reduces the stress placed on the joints between jumper 160 and the respective battery terminals. Further, the raised portion 164 maintains a separation between jumper 160 and battery 102 in areas outside the boundary of the battery terminal. This separation reduces the potential of unwanted electrical bridging between jumper 160 and battery 102.

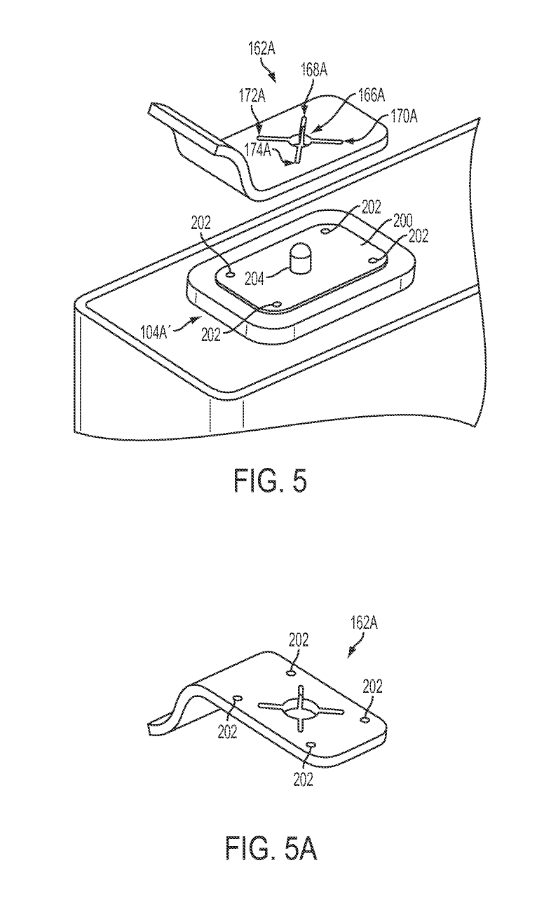

The jumper portion 162A of the disclosure is designed to facilitate robust mechanical and electrical connection with the battery terminal 104A′. Specifically, the first portion 162A is designed to interface with the locator pin 204 of the terminal 104A′ to ensure proper alignment and to secure the first portion 162A in the lateral (i.e., x-y) plane. In the illustrated embodiment, first portion 162A includes through holes to receive the locator pin 204, as shown in FIG. 5. Further, first portion 162A may include other features designed to allow for conductive filler material, such as conductive epoxy or solder, to flow into. This facilitates the robust mechanical and electrical connection. FIG. 5 illustrates wicking openings 168A-174A for receiving conductive wettable material. In the illustrated embodiment, the wicking openings 168A-174A form a crosshair or plus sign (“+”) groove intersecting with the through hole and acting as wicking paths.

An exemplary method of joining first portion 162A to positive terminal 104A′ includes an application of energy to first portion 162A to positive terminal 104A′ in two primary steps. Before any energy is applied, first portion 162A is positioned over the locator pin 204 to assure proper orientation with positive terminal 104A′. A bonding technique wherein energy is applied to first portion 162A and positive terminal 104A′ is then utilized to join first portion 162A to positive terminal 104A′. In one embodiment, the energy is applied in locations corresponding to the terminal's energy directing members 202 to create a metallurgical bond between first portion 162A to positive terminal 104A′. Any suitable bonding technique may be used, such as resistance welding.

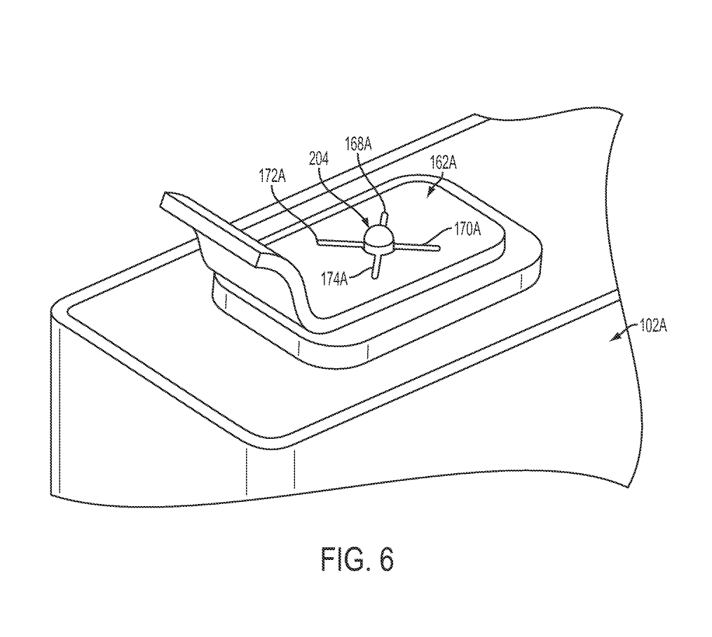

Next, a conductive, wettable material is applied to the portion of the locator pin 204 that protrudes above the top of first portion 162A. For example, a solder disk may be positioned onto the locator pin 204 or a conductive epoxy may be applied to the top of first portion 162A around or on the locator pin 204. Heat is then applied to the conductive, wettable material to facilitate flow of the material into the through hole 166A and wicking openings 168A-174A of first portion 162A, thereby forming a robust electrical connection wherein the conductive, wettable material serves as the primary low resistance electrical current path. The heat may be applied using any known methods, such as a heat bar, a soldering iron, or an IR heat source. Referring to FIG. 6, an assembled view is shown.

Thus, in one embodiment, the process yields a welded joint that provides robust mechanical retention of first portion 162A to positive terminal 104A′ while also having a low resistance electrical path in the solder or conductive epoxy. Moreover, the process yields a terminal system with a first portion 162A that is removably affixed to the battery cell terminal 104A′, wherein sufficient subsequent heat may allow for removal of the jumper tab from the terminal.

Referring to FIG. 5A, energy directing members 202 may be provided on an underside of first portion 162A as opposed to on base surface 200 of positive terminal 104A′.

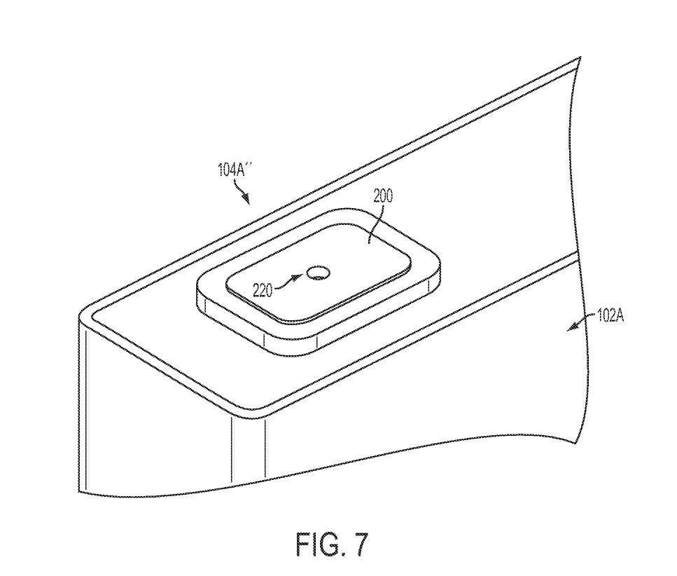

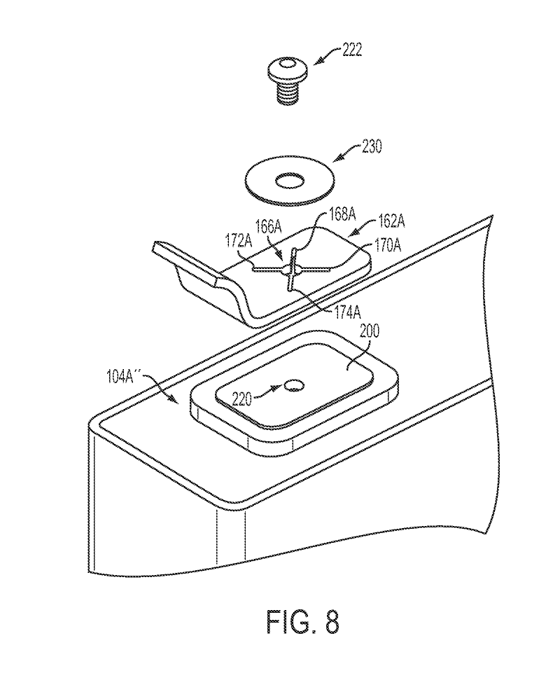

Referring to FIG. 7, an alternative terminal 104K is adapted such that a hole or recess 220 is formed to receive a self tapping fastener 222 (see FIG. 8). While multiple holes 220 may be formed to suit the particular geometry of first portion 162A and positive terminal 104K, a single hole 220 may be sufficient for many applications. Notably, energy directing members are not used to couple first portion 162A to base surface 200 of positive terminal 104K. In one embodiment, aperture 220 is threaded and a threaded fastener is received by aperture 220.

To assemble the battery terminal system, first portion 162A is positioned over recess 220 and a self tapping fastener 222 is installed through hole 166A of first portion 162A and into recess 220 of positive terminal 104K. While any suitable self tapping fastener may be used, FIG. 8 shows a self tapping screw used to secure first portion 162A to positive terminal 104K.

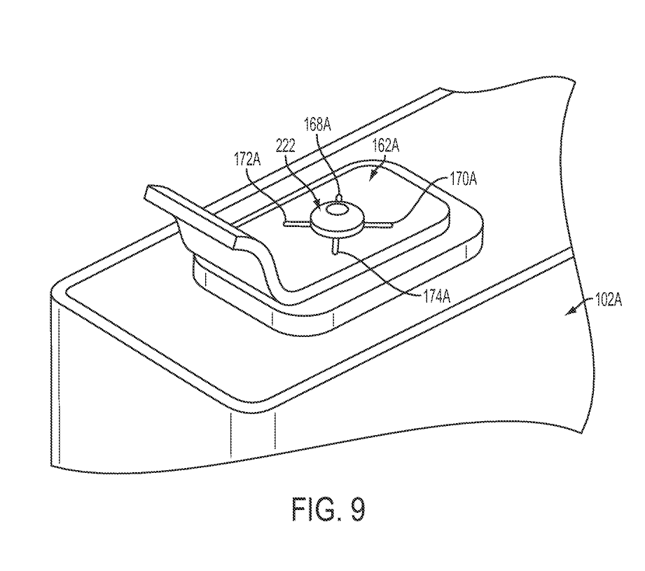

The conductive, wettable material described above is then used to facilitate the robust electrical connection. As shown in FIG. 8, the conductive, wettable material may be a solder perform 230 that is applied to the construction between the top of first portion 162A and the self tapping fastener 222. Another option is for the solder perform 230 or other conductive, wettable material to be applied to the top of the fastener 222, such as the top of the screw head. Heat is then applied to the conductive, wettable material 230 to facilitate flow of the material into the through hole 166A and wicking openings 168A-174A of first portion 162A, thereby forming a robust electrical connection wherein the conductive, wettable material serves as the primary low resistance electrical current path. The heat may be applied using any known methods, such as a heat bar, a soldering iron, or an IR heat source. An illustration of the final battery terminal system is shown in FIG. 9.

Thus, in the embodiment illustrated in FIGS. 7-9, the process yields a reliable mechanical joint that provides robust mechanical retention of first portion 162A to positive terminal 104A″ while also having a low resistance electrical path in the solder or conductive epoxy. Moreover, the method yields a terminal system with a first portion 162A that is removably affixed to positive terminal 104K, wherein sufficient subsequent heat and mechanical reworking may allow for removal of the jumper tab from the terminal.

Referring to FIGS. 10-18, embodiments are provided wherein, the terminal is not modified, but a secondary terminal or base 240 is formed and joined to the battery terminal that facilitates joining of the jumper 160 to the battery terminals. Referring to FIG. 10, the base 240 includes a base member 250, a threaded stud 258 that is passed into aperture 260 and press fit into the base member 250 from the lower side of the base member 250 that is joined to the positive terminal 104A. An exemplary threaded stud is a captive fastener stud that coupled to base member 250 or base member 250′. Exemplary captive fastener studs are available from Captive Fastener Corporation located at 19 Thornton Road in Oakland, N.J. 07436. In one embodiment, aperture 260 is threaded and the captive fastener is replaced with a threaded fastener. The threaded fastener may be welded in place, staked in place, or otherwise secured to base member 250 to prevent the rotation of the threaded fastener relative to the base member 250.

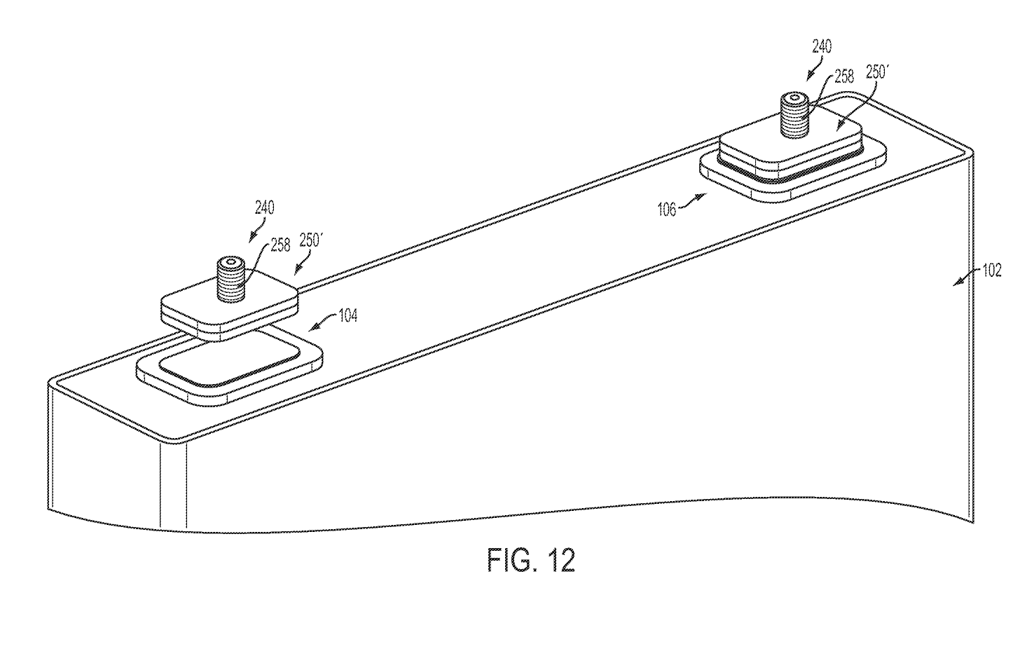

In operation, first portion 162A is positioned over threaded stud 258 and threaded stud 258 is received within hole 166A of first portion 162A. A threaded retainer 266 is threaded onto threaded stud 258 to capture first portion 162A and mechanically couple first portion 162A to base member 250. Assembled base 240 are shown in FIG. 12 being assembled to the terminals of a battery 102.

The base member 250 illustrated in FIG. 10 is a unitary body. The base member may be made of any conductive material. In the illustrated embodiment, base member 250 is made of aluminum.

An alternative base member 250′ is shown in FIG. 11. The alternative base member 250′ includes two layers coupled together. A first layer 252 is made of copper and a second layer 254 is made of aluminum.

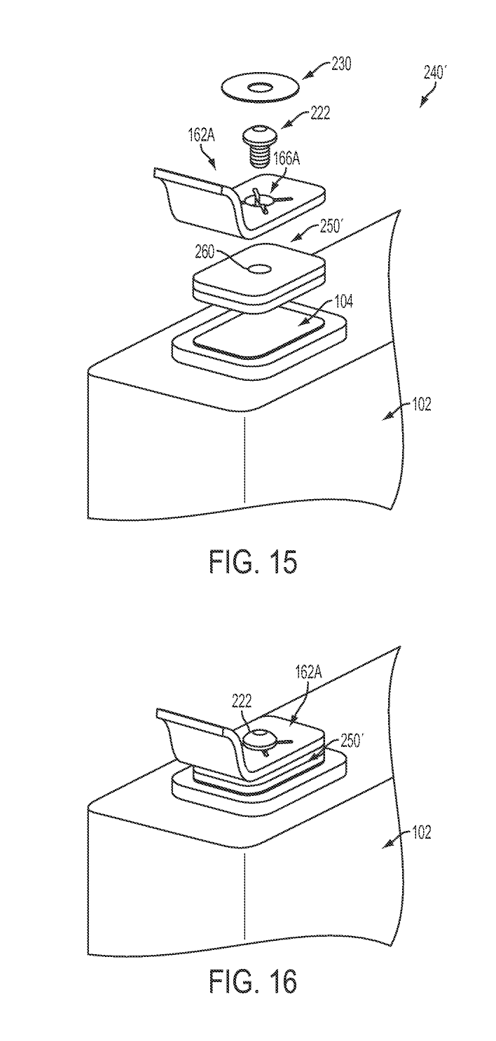

Referring to FIG. 15, an alternative base member 250′ is shown with a hole 260 through at least a portion of the thickness of the base member 250′ to receive a self tapping fastener 222. While multiple holes 260 may be formed to suit the particular geometry of first portion 162A and base member 250′, a single hole 260 may be sufficient for many applications.

To assemble the battery terminal system, first portion 162A is positioned over base member 250′ and a self tapping fastener 222 is installed through hole 166A of first portion 162A and into hole 260 of base member 250′. In one embodiment, aperture 260 is threaded and a threaded fastener is received by aperture 166A and aperture 260.

In the embodiments shown in FIG. 10-18, the base member 250 or 250′ may be any suitable material or combination of materials that facilitates joining to the existing terminal. For example, one such material is aluminum, wherein the joining surfaces may further comprise a silver coating. In another example, the base member 250′ may be a clad combination of aluminum and copper, wherein the aluminum portion is that part of base member 250′ that will be joined to the terminal and the copper portion is that part of base member 250′ that will interface with first portion 162.

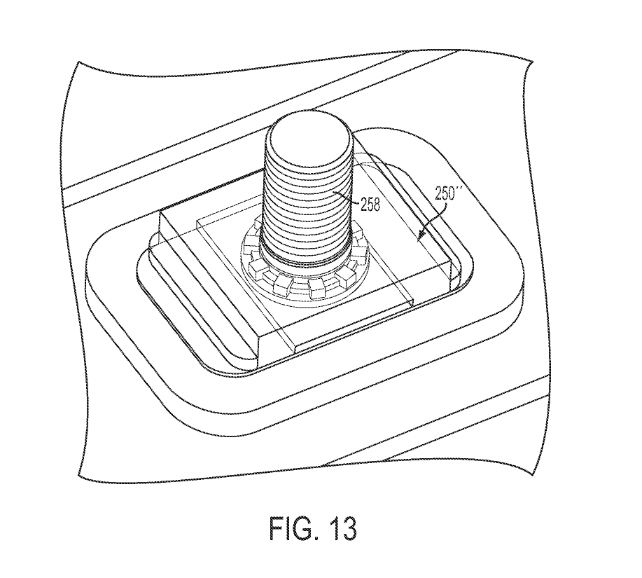

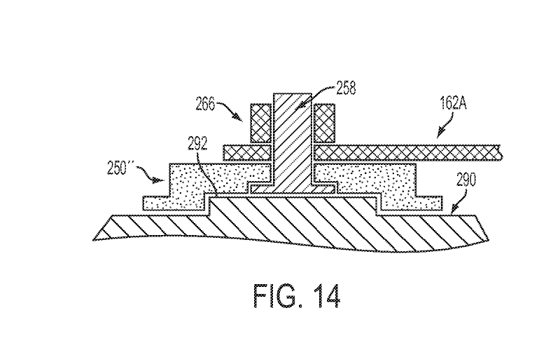

Referring to FIGS. 13 and 14, an alternative base member 250″ is shown. Base member 250″ has a stepped profile to accommodate a raised surface 292 of a battery terminal 290.

The base members 250, 250′, and 250″ may be joined to the battery terminal through any suitable manner. An exemplary suitable manner is welding (e.g., ultrasonic welding, laser welding, and resistance welding).

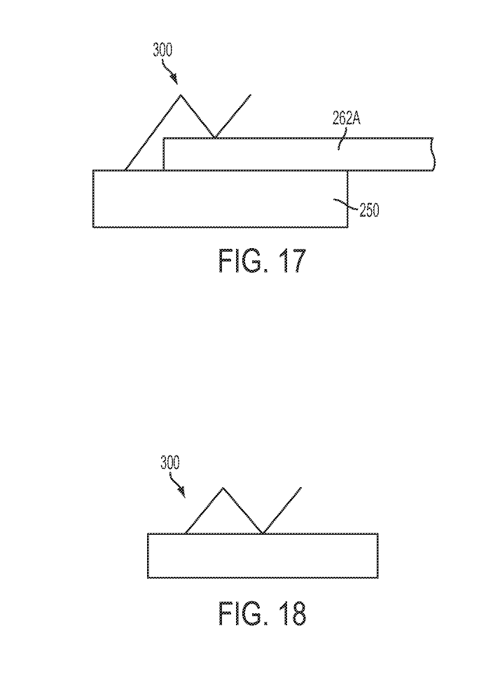

Referring to FIGS. 17 and 18, the threaded stud has been replaced with another retainer, a spring biased member 300. As shown in FIG. 18, in a relaxed state the spring biased member 300 rests against base member 250. As shown in FIG. 17, jumper portion 162A is placed on top of base member 250 and spring biased member 300 has been raised to tension position. The spring bias member holds the jumper portion 162A in contact with base member 250.

One notable advantage of the embodiments shown in FIGS. 10-18 is that the entire assembly is reworkable or may be disassembled without rendering the primary components unusable.

While this disclosure has been primarily focused on terminals of individual battery cells, it should be understood by those skilled in the art that the principles of the design and method disclosed herein may also be applied at the battery module or battery pack level.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A battery terminal system connecting a first battery terminal of a first battery to a second battery terminal of a second battery, the system comprising:
a jumper electrically coupled to the first battery terminal of the first battery and electrically coupled to the second battery terminal of the second battery;
a primary mechanical connection securing the jumper to the first battery terminal of the first battery; and
a primary electrical connection electrically coupling the jumper to the first battery terminal of the first battery, the primary electrical connection providing a lower resistance electrical path between the first battery terminal of the first battery and the jumper than the primary mechanical connection.

2. The battery terminal system of claim 1, wherein the jumper includes at least a first feature to receive a conductive wettable material, the conductive wettable material forming the primary electrical connection.

3. The battery terminal system of claim 2, wherein the conductive wettable material contacts the first battery terminal and contacts the jumper.

4. The battery terminal system of claim 3, wherein the first battery terminal has a base surface protruding from the first battery, the jumper being coupled to the base surface through one of ultrasonic welding and resistance welding.

5. The battery terminal system of claim 3, wherein the first battery terminal has a base surface protruding from the first battery and at least one protrusion extending outward from the base surface away from the first battery, the jumper including at least a second feature to receive the at least one protrusion to couple the jumper to the first battery terminal.

6. The battery terminal of claim 5, wherein the first feature is an opening through the jumper, the conductive wettable material flowing from a top surface of the jumper through the opening to a bottom surface of the jumper contacting the first battery terminal, the conductive wettable material contacting both the first battery terminal and the jumper.

7. The battery terminal of claim 6, wherein the second feature is an opening and the first feature intersects the second feature.

8. The battery terminal of claim 7, further comprising at least one retainer coupled to the at least one protrusion, the at least one retainer holding the jumper relative to the first battery terminal and forming the primary mechanical connection.

9. The battery terminal system of claim 3, wherein the first battery terminal has a base surface protruding from the first battery and at least one recess extending inward from the base surface towards the first battery and further comprising at least one retainer cooperating with at least a second feature of the jumper and the at least one recess of the first battery terminal to hold the jumper relative to the first battery terminal and forming the primary mechanical connection.

10. The battery terminal of claim 9, wherein the first feature is an opening through the jumper, the conductive wettable material flowing from a top surface of the jumper through the opening to a bottom surface of the jumper contacting the first battery terminal, the conductive wettable material contacting both the first battery terminal and the jumper.

11. The battery terminal of claim 10, wherein the second feature is an opening and the first feature intersects the second feature.

12. The battery terminal system of claim 2, wherein the conductive wettable material contacts the jumper and contacts a base positioned between the jumper and the first battery terminal, the base in cooperation with the conductive wettable material electrically coupling the jumper and the first battery terminal.

13. A battery terminal system connecting a first battery terminal of a first battery to a second battery terminal of a second battery, the system comprising:
a first base coupled to the first battery terminal of the first battery;
a jumper removably coupled to the first base, the jumper being electrically coupled to the first battery terminal of the first battery through the first base and electrically coupled to the second battery terminal of the second battery resulting in the first battery terminal of the first battery being electrically coupled to the second battery terminal of the second battery; and
at least one retainer securing the jumper to the first base.

14. The battery terminal system of claim 13, wherein the first base is coupled to a base surface of the first battery terminal through one of ultrasonic welding and resistance welding.

15. The battery terminal system of claim 13, wherein the first base includes a bottom portion coupled to a base surface of the first battery terminal of the first battery and a top portion including a jumper seat surface and at least one protrusion extending outward from the jumper seat surface, the jumper including at least one opening to receive the at least one protrusion, the at least one retainer being coupled to the at least one protrusion, the at least one protrusion and the at least one retainer cooperating to couple the jumper to the first base.

16. The battery terminal of claim 15, wherein the jumper further includes at least one wicking opening extending from a top surface of the jumper to a bottom surface of the jumper contacting the jumper seat surface of the first base, a conductive wettable material being positioned within the at least one wicking opening and contacting both the first base and the jumper.

17. The battery terminal of claim 16, wherein the at least one wicking opening and the at least one opening intersect.

18. The battery terminal system of claim 13, wherein the first base includes a bottom portion coupled to a base surface of the first battery terminal of the first battery and a top portion including a jumper seat surface and at least one recess extending inward from the jumper seat surface, the jumper including at least one opening to receive the at least one retainer, the at least one retainer passing into the at least one recess, the first base and the at least one retainer cooperating to couple the jumper to the first base.

19. The battery terminal of claim 18, wherein the jumper further includes at least one wicking opening extending from a top surface of the jumper to a bottom surface of the jumper contacting the jumper seat surface of the first base, a conductive wettable material being positioned within the at least one wicking opening and contacting both the first base and the jumper.

20. The battery terminal system of claim 13, wherein the at least one retainer is coupled to the first base to capture the jumper between the at least one retainer and the first base and to hold the jumper in electrical contact with the first base.

21. The battery terminal system of claim 13, wherein the at least one retainer is spaced apart from the first battery terminal of the first battery, the first base being positioned between the at least one retainer and the first battery terminal of the first battery.

22. The battery terminal system of claim 13, wherein the jumper is spaced apart from the first battery terminal of the first battery, the first base being positioned between the jumper and the first battery terminal of the first battery.

23. A battery terminal system connecting a first battery terminal of a first battery to a second battery terminal of a second battery, the system comprising:
a jumper including a first portion electrically coupled to the first battery terminal of the first battery and a second portion electrically coupled to the second battery terminal of the second battery resulting in the first battery terminal of the first battery being electrically coupled to the second battery terminal of the second battery, the first portion including at least one wicking opening; and
a conductive wettable material positioned within the at least one wicking opening.

24. The battery terminal system of claim 23, wherein the conductive wettable material forms a primary electrical connection between the jumper and the first battery terminal of the first battery terminal of the first battery.

25. The battery terminal system of claim 24, wherein the first portion of the jumper includes at least one opening to receive at least one feature that locates the first portion of the jumper relative to the first battery terminal of the first battery, the at least one opening intersecting the at least one wicking opening.

26. The battery terminal system of claim 25, wherein a first wicking opening extends radially from a first opening which receives a first feature

27. The battery terminal system of claim 26, wherein the first feature is one of a protrusion and a fastener.
